(19) United States
(12) Patent Application Publication
(10) Pub. No.: US 2008/0247177 A1
(43) Pub. Date: Oct. 9, 2008

(54) Luminescent device

(75) Inventors: Yoshiharu Tanaka, Aichi-ken (JP); Takao Adachi, Aichi-ken (JP); Akihiro Misawa, Aichi-ken (JP); Shigeru Yabuya, Aichi-ken (JP); Minoru Shibata, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD, Aichi-ken (JP)

(21) Appl. No.: 12/068,652

(22) Filed: Feb. 8, 2008

(30) Foreign Application Priority Data
Feb. 9, 2007 (JP) P2007-030068
Feb. 9, 2007 (JP) P2007-030368
Feb. 21, 2007 (JP) P2007-040372
Aug. 28, 2007 (JP) P2007-221191
Sep. 28, 2007 (JP) P2007-253603

(51) Int. Cl. F21V 29/00

(52) U.S. Cl. 362/373

(57) ABSTRACT

A luminescent device includes: a light source; a housing for accommodating the light source, a heat discharging member including a heat transfer portion and a heat dissipation portion and passed through the housing, the heat transfer portion being mounted on the light source and the heat dissipation portion being located outside the housing; a seal portion for sealing a gap between the heat discharging member and the housing; and optical axis adjusting device for adjusting an optical axis of the light source, wherein the heat transfer portion or the seal portion is deformed so as to follow an angular change of the optical axis of the light source by the optical axis adjusting device.

### BACKGROUND OF THE INVENTION

1. Field of the Invention

The present invention relates to a luminescent device, and more particularly to the improvement of a heat dissipation mechanism of a luminescent device served as a headlight for a vehicle, for example.

2. Related Art

Luminescent devices are used in various applications including indoor lighting fixtures and lamp fittings for vehicles, but countermeasures against heat are important in luminescent devices used in indoor lighting fixtures and lamp fittings such as a vehicle headlight whose quantities of light are large. As a countermeasure against heat, one using a heat pipe is known. For example, JP-A-2006-107875 discloses a luminescent device having a heat pipe in which a heat input portion is attached to a light source in a housing, and a heat discharging portion is attached to a heat sink outside the housing. In this luminescent device, heat generated from the light source is released to outside the housing by means of the heat pipe. In addition, JP-A-2006-164967 discloses a luminescent device which releases the heat of the light source to outside the housing by making use of a loop-shaped heat pipe.

In luminescent devices such as headlights for vehicles and indoor downlights, it is necessary to make angular adjustment of the optical axis. If the heat pipe disclosed in one of the above-described documents is adopted as a countermeasure against heat in such a luminescent device, since the positions of respective members are fixed, the installation angle of the entire device must be changed in order to make the angular adjustment of the optical axis. Such a change of the installation angle involves complicated operation. In addition, it is difficult to perform the angular adjustment of the optical axis after the luminescent device has been assembled once. Thus, configurations adopted in conventional counter measures against heat are not such that consideration is given to the angular adjustment of the optical axis.

### SUMMARY OF THE INVENTION

Accordingly, an object of the invention is to provide a luminescent device which excels in the heat dissipation characteristic and facilitates the angular adjustment of the optical axis. Another object of the invention is to attain improvement of the heat dissipation characteristic while preventing an increase in the device size and an increase in weight.

To attain the above object, there is provided a luminescent device comprising:

a light source;

a housing for accommodating the light source,

a heat discharging member including a heat transfer portion and a heat dissipation portion and passed through the housing, the heat transfer portion being mounted on the light source and the heat dissipation portion being located outside the housing;

a seal portion for sealing a gap between the heat discharging member and the housing; and

an optical axis adjusting device for adjusting an optical axis of the light source,

wherein the heat transfer portion or the seal portion is deformed so as to follow an angular change of the optical axis of the light source by the optical axis adjusting device.

In the luminescent device according to the invention, the heat transfer portion or the seal portion is deformed so as to follow an angular change of the optical axis of the light source by the optical axis adjusting device. Consequently, it becomes unnecessary to change the installation position of the entire device in order to make the angular adjustment of the optical axis of the light source. Namely, the angular adjustment of the optical axis of the light source can be performed easily.

Meanwhile, the heat transfer portion of the heat discharging member propagates the heat of the light source to the heat dissipation portion located outside the housing. As a result, the heat of the light source is efficiently released to outside the housing, and a high dissipation effect is exhibited. Furthermore, as the gap between the heat discharging member and the housing is sealed by the seal portion, a waterproofing effect is demonstrated.

As described above, the luminescent device according to the invention facilitates the angular adjustment of the optical axis, and has combined an excellent heat dissipation characteristic and an excellent waterproof characteristic.

According to another aspect of the invention, there is provided a headlight for a vehicle comprising:

a light source accommodated in a housing;

a heat dissipating member disposed outside the housing; and

a flexible heat conducting member for conducting the heat of the light source to the heat dissipating member.

In the headlight for a vehicle according to the above-described aspect of the invention, the heat of the light source is propagated through the heat conducting member to the heat dissipating member provided outside the housing, and is released to outside the housing. Since the heat conducting member is flexible, the heat conducting member can be deformed by following a change of the installation angle of the light source. Hence, it is easily possible to make the angular adjustment of the optical axis by changing the installation angle of the light source even after assembly.

In the present application, there is also provided a headlight for a vehicle comprising:

a light source accommodated in a housing;

a thermally conductive member mounted on the light source;

a heat pipe in which a heat input portion disposed in the housing is connected to the thermally conductive member, and a heat dissipation portion disposed outside the housing is connected to a vehicle frame or a heat exchanger.

In the above-described headlight for the vehicle, the light source is mounted on the heat input portion of the heat pipe through the thermally conductive member. As a result, the heat of the light source is efficiently propagated to the heat input portion. Meanwhile, the heat dissipation portion of the heat pipe is connected to the vehicle frame or the heat exchanger. Since the vehicle frame and the heat exchanger have large heat capacities, the heat which entered into the heat pipe from the heat input portion is efficiently released from the heat dissipation portion. Thus, an excellent dissipation effect is exhibited by virtue of the efficient propagation of heat into the heat input portion and the efficient release of heat from the heat dissipation portion. In addition, the headlight for a vehicle according to the invention has a simple structure, and can be easily made compact an lightweight.

### BRIEF DESCRIPTION OF THE DRAWINGS

FIG. 1 is a schematic diagram of a heat pipe 10;

FIG. 2 is a perspective view of a headlight 1 according to a first embodiment of the invention;

FIG. 3 is a perspective view of a light source unit 3;

FIG. 4A is a schematic view, taken from the angle shown at I in FIG. 3, of the light source unit 3;

FIG. 4B is a schematic view, taken from the angle shown at II in FIG. 3, of the light source unit 3;

FIG. 5A is a partially cross-sectional view, taken from a lateral direction, of a downlight 50 according to a second embodiment of the invention;

FIG. 5B is a partially cross-sectional view taken from an angle shown at III in FIG. 5A;

FIG. 6 is a schematic view at the time of angular adjustment corresponding to FIG. 5A;

FIG. 7 is a schematic view at the time of angular adjustment corresponding to FIG. 5B;

FIG. 8 is a vertical cross-sectional view of a headlight 800 according to a third embodiment of the invention;

FIG. 9 is a perspective view of a part of a light source unit 850, a heat pipe 830, and a heat sink 840;

FIG. 10 is a vertical cross-sectional view of a headlight 900 for a vehicle according to a fourth embodiment of the invention; and

FIG. 11 is a vertical cross-sectional view of a headlight 950 for a vehicle according to a fifth embodiment of the invention.

FIG. 12 is a perspective view of a light source unit 503 according to a sixth embodiment;

FIG. 13A is a schematic view, taken from the angle shown at I in FIG. 12, of the light source unit 503;

FIG. 13B is a schematic view, taken from the angle shown at II in FIG. 12, of the light source unit 503; and

FIG. 14 is a perspective view of a headlight 500 according to a seventh embodiment of the invention.

FIG. 15 is a vertical cross-sectional view of a headlight 701 for a vehicle according to an eight embodiment; and

FIG. 16 is a partial perspective view of the headlight 701 for a vehicle.

### DETAILED DESCRIPTION OF THE PREFERRED EMBODIMENTS

Hereafter, a detailed description will be given of constituent elements of the luminescent device according to the invention.

### (Light Source)

The type of light source is not particularly limited, but should preferably be an LED lamp. The reason is that the LED lamp has advantages such as being compact and resistant to vibrations and impacts. The type of LED lamp is not particularly limited, and it is possible to adopt various types such as a round type, a surface mounted (SMD) type. The luminescent color of the LED lamp is not particularly limited, and it is possible to use LED lamps of desired luminescent colors such as white, blue, red, and green. A plurality of LED lamps may be used as the light source.

It is preferable to use an LED lamp using a mounting substrate whose thermal conductivity is high, including one made of a metal such as cupper, silver or aluminum, or one made of a ceramic. This is because the heat of the light source can be efficiently propagated to a below-described heat transfer portion.

Further, it is preferred that, by making use of a thermally conductive seat (or thermally conductive member) for mounting the light source thereon, one end of a below-described heat conducting member be connected to that seat, while the other end of the heat conducting member be connected to a below-described heat dissipating member. This is because the light source can be mounted stably, and the heat of the light source is efficiently propagated to the heat conducting member so as to be released from the heat dissipating member. As the material of the seat, it is possible to adopt carbon graphite or a metal such as copper or aluminum. In the case where an LED lamp is used as the light source, the seat may preferably be brought into contact with substantially the entirety of the reverse surface of the LED chip mounting substrate. This is for propagating the heat of the light source more efficiently to the heat conducting member.

### (Housing)

The housing accommodates the light source. A reflector for reflecting the light from the light source and a lens (outer lens) for transmitting the light of the light source may be provided in the housing. A part of an inner wall of the housing may be provided with reflection treatment, and may be used as a reflector.

(Heat Discharging member)

The heat discharging member includes a heat transfer portion and a heat dissipation portion. The heat discharging member is passed through the housing such that the heat transfer portion is located inside the housing, while the heat dissipation portion is located outside the housing. The light source is mounted on the heat transfer portion. As a result, the heat of the light source is propagated to the heat transfer portion. After moving to the heat dissipation portion, the propagated heat is radiated from the heat dissipation portion to the outside of the housing. By using a heat sink, the radiation fin of the heat sink can be set as the heat dissipation portion. The form of the radiation fin is not particularly limited, but it is possible to adopt a form in which a plurality of projecting portions of a plate shape, a pin shape, or the like are formed. As the material of the heat sink, it is preferable to adopt a metallic material whose thermal resistance is small, such as aluminum, copper, or the like. A plurality of heat sinks may be used.

A heat conducting member is preferably interposed between the heat transfer portion and the light source. This is because the heat of the light source can be efficiently propagated to the heat transfer portion, and the heat dissipation effect improves. The material of the heat conducting member is sufficient if its thermal conductivity is high, and it is possible to adopt, for example, carbon graphite or a metal such as copper or silver.

The heat transfer portion is preferably constituted by a heat pipe. This is because the heat of the light source can be propagated more efficiently to the heat transfer portion. The heat pipe has a pipe-like structure having a capillary wick in its interior, and a small amount of a working fluid (hydrochlorofluorocarbon, water, etc.) is vacuum sealed in the interior of the heat pipe. The operating principle of the heat pipe is as follows. When a heat input portion of the heat pipe is heated, the working fluid (liquid) is vaporized in the heat input portion. The vaporized working fluid moves through the interior of the heat pipe and reaches a heat discharging portion, whereupon the vaporized working fluid is condensed and liquefied due to a temperature drop. The liquefied working fluid moves to the heat input portion due to a capillary phenomenon based on the wick. At this time, the heat fetched from the heat input portion is discharged from the heat discharging portion by virtue of the absorption of latent heat of vaporization of the working fluid in the heat input portion as well as the release of the latent heat of vaporization in the heat discharging portion. As the heat input portion is mounted on the light source and the heat discharging portion is mounted on the heat dissipation portion, the heat of the light source is efficiently released to outside the housing, thereby efficiently cooling the light source. The length and size of the heat pipe can be appropriately determined in correspondence with the degree of the required heat dissipation effect and the installation space.

In one form of the invention, the heat pipe has a first bent portion located outside the housing. The outer shape of the heat pipe is generally linear, and one end side of the heat pipe serves as the heat input portion, while the other end side serves as the heat discharging portion. The heat input portion is mounted on the light source, and the heat discharging portion is mounted on the heat dissipation portion. The first bent portion can be formed by bending a portion of the heat pipe into, for example, a semicircular shape, a chevron shape, an S shape, or the like. The first bent portion may be formed by a plurality of bent portions. The first bent portion becomes easily deflected (deformed) in a particular direction by virtue of the bent shape. The shape of the heat pipe may be set in a spiral shape. By so doing, the heat pipe is easily deflected in the direction of its entire circumference.

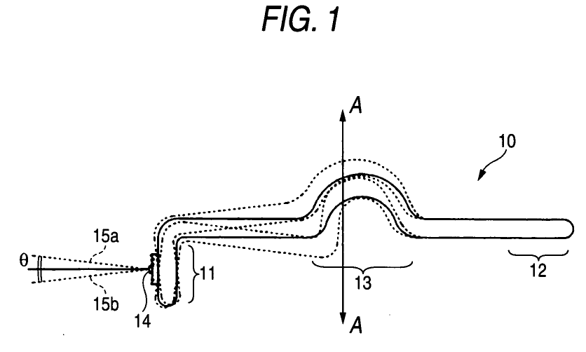

Referring to a schematic diagram of a heat pipe 10 shown in FIG. 1, a description will be given of a direction (first direction) in which a first bent portion 13 is deflected. As shown in FIG. 1, the heat pipe 10 is substantially linear, and one end side thereof serves as a heat input portion 11, while the other end portion thereof serves as a heat discharging portion 12. The first bent portion 13 is provided substantially in the center of the heat pipe 10. The first bent portion 13 has a shape in which it is semicircularly bent upward in the plane of the drawing in FIG. 1. The broken line in FIG. 1 shows the state in which the first bent portion 13 is deflected. It should be noted that a light source 14 is mounted on the heat input portion 11, and the heat discharging portion 12 is fixed to a heat sink (not shown). As shown in FIG. 1, the first bent portion 13 is deflected in the directions of arrows A which are its projecting direction (upward in the plane of the drawing in FIG. 1) and its opposite direction. In conjunction with it, the heat input portion 11 side moves in the direction of the arrow A, thereby adjusting the angle of an optical axis 15 of the light source 14. The first bent portion 13 can be bent such that the adjustable angular range (angle θ) of the optical axis 15 becomes 5° to 30°, preferably 5° to 20°.

In one form of the invention, the heat pipe has a second bent portion which is deflected in a second direction. The second bent portion is also formed outside the housing in the same way as the first bent portion. The second bent portion should preferably be perpendicular to the first direction. If this arrangement is adopted, the angular adjustment of the optical axis becomes possible over the entire circumferential range by making use of the first bent portion and the second bent portion. The second bent portion is formed by bending a portion of the heat pipe in the same way as the first bent portion. The second bent portion may be formed by a plurality of bent portions. The shape of the second bent portion may be different from the shape of the first bent portion. The second bent portion can be bent such that the adjustable angular range (angle θ) of the optical axis of the light source becomes 5° to 30°, preferably 5° to 20°. It should be noted that the position where the first bent portion is formed and the position where the second bent portion is formed are sufficient if they are located outside the housing, and the order of arrangement of the first bent portion and the second bent portion is not limited. An interval at which the first bent portion and the second bent portion are disposed is not particularly limited, and can be appropriately determined by taking the installation space and the like into consideration.

It should be noted that the heat pipe may further have a bent portion which is deflected in a direction different from those of the first direction and the second direction. Meanwhile, in a case where a below-described seal portion is constituted by a flexible boot member, it is possible to use a rectilinear heat pipe.

The heat dissipation portion of the heat pipe may be disposed outside the housing, and may be mounted on a vehicle frame or a heat exchanger. The vehicle frame and the heat exchanger are normally made of metal and have sufficiently large heat capacities. In the invention, attention is focused on this aspect, and efficient heat dissipation is effected by connecting the heat dissipation portion of the heat pipe to the vehicle frame or the heat exchanger. It should be noted that the vehicle frame in this specification is assumed to include a metallic member formed continuously on the vehicle frame, such as a front end module. On the other hand, as the heat exchanger in this specification, it is possible to cite by way of example a radiator or an intercooler in the vehicle. If the heat dissipation portion is connected to the heat exchanger, the heat dissipation action of the heat dissipation portion is further promoted owing to its heat exchange action.

### (Heat Dissipating Member)

The heat dissipating member or heat dissipating portion used in the invention is provided outside the housing. The configuration of the heat dissipating member is not particularly limited, and it is possible to use, for instance, a heat sink having a plurality of metallic fins with high thermal conductivity. The size of the heat dissipating member can be determined by taking into consideration the thermal capacity required. In addition, a member having a large thermal capacity, such as a vehicle frame or a radiator of the vehicle, may be used as the heat dissipating member of the invention.

### (Heat Conducting Member)

The heat pipe as described above has a pipe-like structure having a capillary wick in its interior, and a small amount of a working fluid (hydrochlorofluorocarbon, water, etc.) is vacuum sealed in the interior of the heat pipe. The use of such a heat pipe could constitute one cause of an increase in the device size and an increase in weight.

Accordingly, a heat conducting member may alternatively used for the heat transfer portion to conduct the heat of the light source to the heat dissipating member or heat dissipating portion. The heat conducting member is flexible, and a graphite sheet or the like is preferably used as its material. The reason is that the graphite sheet has high thermal conductivity, is flexible, and is easy to handle. The term “flexible” referred to herein means a property in which the material possesses flexibility and is easily curved, bent, or extended or contracted. Since the heat conducting member is flexible, a portion of the heat conducting member undergoes deformation such as curving, bending, twisting, extension, or contraction by following the change of the installation angle of the light source. The heat conducting member is mounted between the light source and the heat dissipating member in a slackened state. The term “slackened state” referred to herein means that the length of the heat conducting member from its point of contact with the light source to its point of contact with the heat dissipating member is longer than the distance from the light source to the heat dissipating member, and at least a portion of the heat conducting member is deflected. As the heat conducting member is thus slackened, it is possible to prevent an unwanted tension from being applied to the heat conducting member when the heat conducting member undergoes deformation by following the change of the installation angle of the light source. Consequently, the breakage or falling off of the heat conducting member. Although the shape of the heat conducting member is not particularly limited, the heat conducting member should preferably have a sufficient length for providing the aforementioned slack. A plurality of heat conducting members may be provided at a plurality of locations. For example, two graphite sheets may be used and may be respectively provided at two locations. The number of the heat conducting members used can be determined in accordance with the material of the heat conducting member used and its thermal conductivity as well as the type of the light source. The thermal conductivity of the graphite sheet is approximately 400 W/mk to 1700 W/mk in a planar direction, and one graphite sheet can be used for three LED lamps, for example.

### (Seal Portion)

The seal portion seals a gap between the housing and the heat discharging member. As a result, the interior of the housing is made waterproof. The seal portion should preferably be constituted by a flexible boot member. This is because the seal portion is easily deformed so as to follow a change in the optical axis of the light source by a below-described optical axis adjusting device.

In one form of the invention, by using a heat sink, a portion of the heat sink is connected to the light source, the heat sink is passed through the housing such that the radiation fin of the heat sink is located outside the housing, and the gap between the heat sink and the housing is sealed by a flexible seal portion. By virtue of this arrangement, of the heat sink, the portion located inside the housing serves as the heat transfer portion, and the radiation fin serves as the heat dissipation portion. As a result, the number of parts is reduced, thereby attaining a reduction of the manufacturing cost and improving the operating efficiency in assembly.

### (Optical Axis Adjusting Device)

The optical axis adjusting device makes possible the angular adjustment of the optical axis by changing the angle of the light source. A known configuration can be adopted as the optical axis adjusting device. The angular adjustment of the optical axis by the optical axis adjusting device can be performed manually or automatically. For example, the angular adjustment of the optical axis may be performed automatically by the auto-leveling function for correcting a change of the angle of the optical axis accompanying a change of the laden weight of the vehicle. Alternatively, the angular adjustment of the optical axis may be performed automatically by the adaptive front lighting system (AFS) for illuminating the traveling direction in interlocking relation to the steering angle of the vehicle.

Namely, in one of embodiments of the invention, there is provided an optical axis adjusting device for changing the installation angle of the light source in correspondence with the steering angle of the steering wheel of the vehicle. By virtue of the optical axis adjusting device, the headlight actively illuminates the traveling direction of the vehicle, so that the visibility of the driver improves. A known mechanism can be adopted as the optical axis adjusting device in the invention, and it is possible to adopt, for instance, a mechanism in which the light source or the seat for mounting the light source thereon is tilted or rotated in a predetermined direction by the driving force of a motor in correspondence with the steering angle of the steering wheel of the vehicle.

Hereafter, a description will be given of the embodiments of the invention.

### First Embodiment

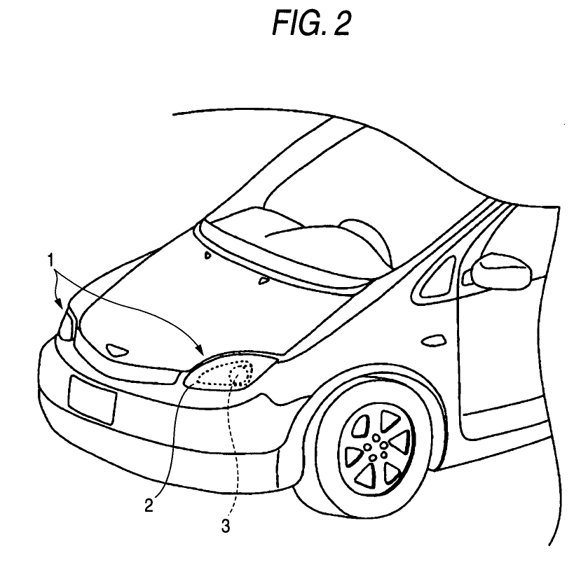

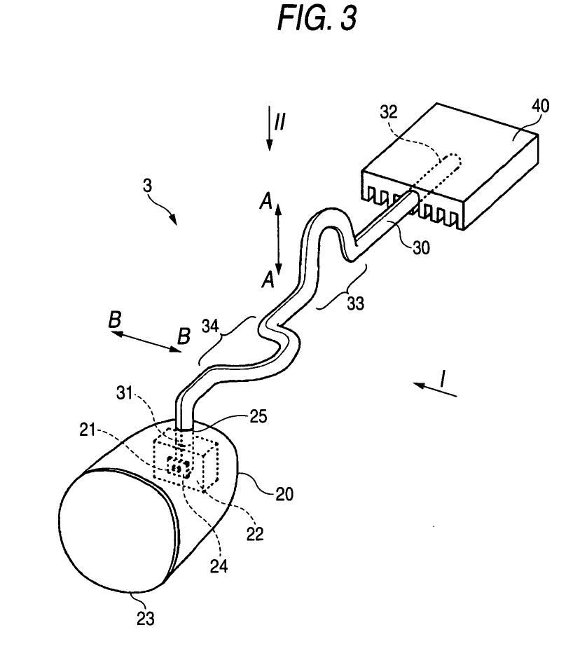

FIG. 2 shows a perspective view of a headlight 1 of a vehicle according to a first embodiment of the invention. As shown in FIG. 2, the headlight 1 has an outer lens 2 and a light source unit 3. FIG. 3 shows a perspective view of the light source unit 3 of the headlight 1. As shown in FIG. 3, the light source unit 3 is comprised of a housing 20, a heat pipe 30, and a heat sink 40. The housing 20 has a light source 21 accommodated therein. The light source 21 is mounted on one end portion (heat input portion 31) of the heat pipe 30 through a heat conducting member 22. The heat conducting member 22 is formed of aluminum. A lens 23 is provided on the light emitting side of the light source 21 of the housing 20. The light source 21 is a white light emitting LED lamp of a surface mounted type. It should be noted that, by taking the heat dissipation characteristic into consideration, a ceramic-made substrate is adopted as a mounting substrate 24 on which an LED chip is mounted. The heat pipe 30 has the heat input portion 31 disposed on one end side for mounting the light source 21 thereon, a heat discharging portion 32 disposed on the other end side, and a first bent portion 33 and a second bent portion 34 both disposed in the vicinities of a central portion. The heat sink 40 is mounted on the heat discharging portion 32. The heat sink 40 is formed of aluminum and has a multiplicity of fins. It should be noted that the heat sink 40 is fixed to a vehicle frame (not shown).

The first bent portion 33 is bent in a substantially semicircular shape in the first direction (indicated by the arrows A in FIG. 3) which is a direction perpendicular to the traveling direction of the vehicle and the ground surface. Meanwhile, the second bent portion 34 is bent in a substantially semicircular shape in the second direction (indicated by arrows B in FIG. 3) which is perpendicular to the first direction and the longitudinal direction of the vehicle. Both of the first bent portion 33 and the second bent portion 34 are formed outside the housing 20. The heat pipe 30 has a diameter of approximately 6 mm and a length of approximately 300 mm. The housing 20 has a through hole 25 through which the heat pipe 30 is passed. A waterproof packing (not shown) is fitted to the through hole 25 to thereby prevent the invasion of water and the like into the housing 20 through the through hole 25. Additionally, the whole edge portion of the lens 23 is welded to the housing 20. As a result of these, the interior of the housing 20 is kept in a waterproof state.

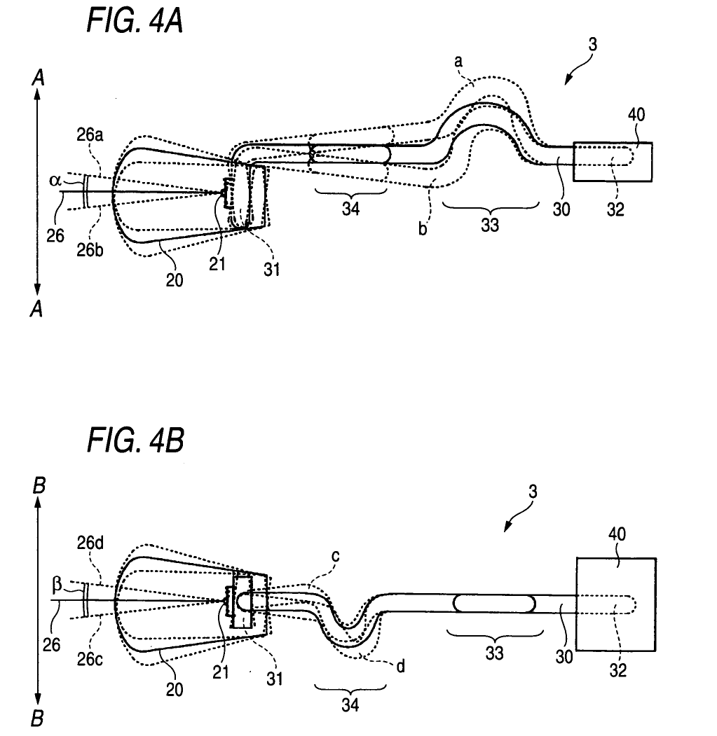

Next, a description will be given of the angular adjustment of the optical axis of the headlight 1. FIG. 4A shows a schematic view, taken from the angle shown at I in FIG. 3, of the light source unit 3. FIG. 4B shows a schematic view, taken from the angle shown at II in FIG. 3, of the light source unit 3. In FIGS. 4A and 4B, the state in which the first bent portion 33 or the second bent portion 34 is deflected is shown by the dotted line. As shown in FIG. 4A, the first bent portion 33 is deflected in the direction of the arrows A. The heat discharging portion 32 side is fixed to the vehicle body, and the heat input portion 31 side moves as shown at a and b in FIG. 4A. In conjunction with this, an optical axis 26 of the light source 21 changes in a range between an optical axis 26a and an optical axis 26b. The angular adjustment of the optical axis 26 is carried out in this range. An angle a formed by the optical axis 26a and the optical axis 26b is approximately 5° to approximately 20° in the direction of the arrows A.

On the other hand, the second bent portion 34 is deflected in the direction of the arrows B, as shown in FIG. 4B. Since the heat discharging portion 32 side is fixed to the vehicle body, the heat input portion 31 side moves as shown at c and d in FIG. 4B. In conjunction with this, the optical axis 26 of the light source 21 changes in a range between an optical axis 26c and an optical axis 26d. The angular adjustment of the optical axis 26 is carried out in this range. An angle β formed by the optical axis 26c and the optical axis 26d is approximately 5° to approximately 20° in the direction of the arrows B.

Since, as described above, the angular adjustment of the optical axis 26 can be made in the range between approximately 5° and approximately 20° in the directions of the arrows A and B, respectively, angular adjustment can be made in the range between approximately 5° and approximately 20° in all directions by combining them. Namely, in the headlight 1, the angular adjustment of the optical axis 26 can be made by bending the respective bent portions 33 and 34 without changing the installation angle of the entire device, so that the operation does not become complicated. Furthermore, the angular adjustment of the optical axis 26 can be easily performed once the device has been assembled.

Incidentally, the heat generated from the light source 21 propagates to the heat input portion 31 of the heat pipe 30 through the heat conducting member 22. The heat which reached the heat input portion 31 moves efficiently to the heat discharging portion 32 by virtue of the radiating action of the heat pipe 30. The heat which moved to the heat discharging portion 32 is released to the outside through the heat sink 40. Thus, in the headlight 1, the heat of the light source 21 is efficiently released to the outside, thereby preventing the overheating of the light source 21.

As described above, despite its simple configuration the headlight 1 has combined an excellent heat dissipation characteristic based on the heat pipe 30 and the ease of angular adjustment of the optical axis 26.

### Second Embodiment

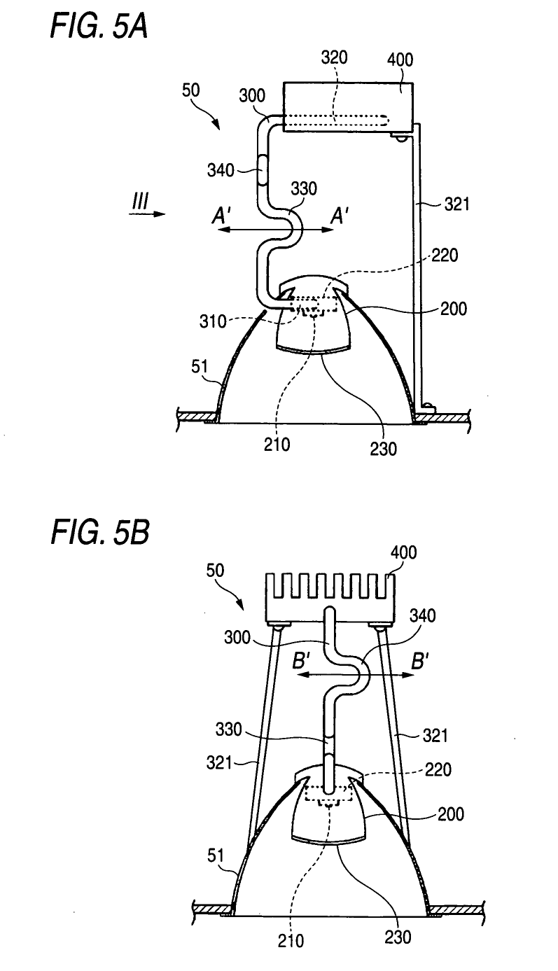

FIG. 5A shows a partially cross-sectional view, taken from a lateral direction, of a downlight 50 according to a second embodiment of the invention. FIG. 5B shows a partially cross-sectional view taken from an angle shown at III in FIG. 5A. The downlight 50 is embedded in an indoor ceiling. The downlight 50 is comprised of a reflector 51, a housing 200, a heat pipe 300, and a heat sink 400. The reflector 51 has the shape of a bowl and is installed so as to be open to the indoor side. The housing 200 is installed in a deepest portion of the reflector 51. The housing 200 has a light source 210 accommodated therein. The light source 210 is mounted on one end portion (heat input portion 310) of the heat pipe 300 through a heat conducting member 220. A lens 230 is provided on the light emitting side of the light source 210. The light source 210 is a white light emitting LED lamp of the surface mounted type. The heat pipe 300 has the heat input portion 310 disposed on one end side for mounting the light source 210 thereon, a heat discharging portion 320 disposed on the other end side, and a first bent portion 330 and a second bent portion 340 disposed in the vicinities of a central portion. The heat sink 400 is mounted on the heat discharging portion 320. The heat sink 400 is formed of aluminum, has a multiplicity of fins, and excels in the heat dissipation characteristic. It should be noted that the heat sink 400 is fixed to a ceiling by means of a fixing member 321.

The first bent portion 330 is bent in a substantially semicircular shape in a first direction (indicated by arrows A′ in FIG. 5A) which is a horizontal direction. Meanwhile, the second bent portion 340 is bent in a substantially semicircular shape in a second direction (indicated by arrows B′ in FIG. 5B) which is a horizontal direction and perpendicular to the first direction. The first bent portion 330 and the second bent portion 340 are formed outside the reflector 51. The heat pipe 300 has a diameter of approximately 4 mm and a length of approximately 300 mm.

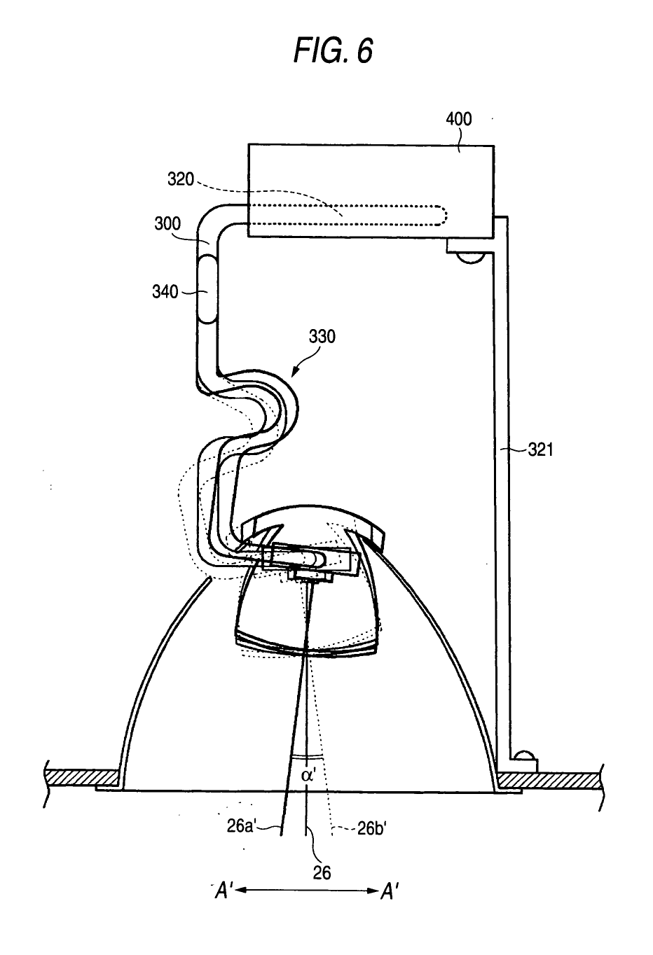

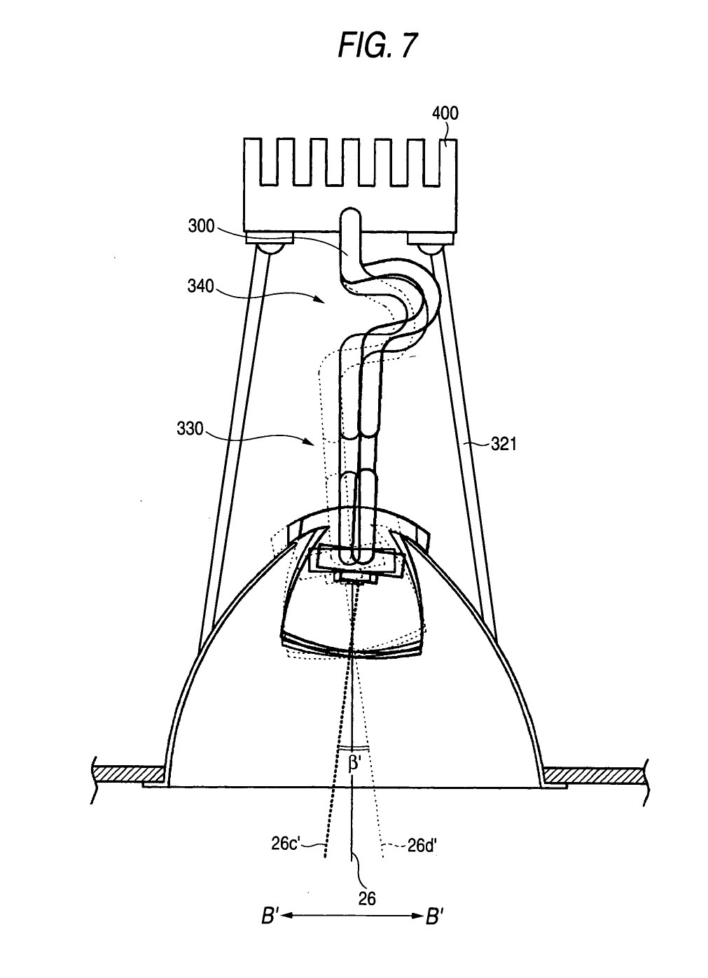

Next, a description will be given of the angular adjustment of the optical axis of the downlight 50. FIGS. 6 and 7 show schematic views at the time of angular adjustment corresponding to FIGS. 5A and 5B, respectively. In FIGS. 6 and 7, states in which the respective bent portions 330 and 340 are deflected are shown by the dotted line and the thick line. As shown in FIG. 6, the first bent portion 330 is deflected in the direction of the arrows A′. The heat discharging portion 320 is fixed to the ceiling through the heat sink 400, and the angle of the optical axis 26 of the light source 210 mounted on the heat input portion 310 changes, as shown by the dotted line and the thick line in FIG. 6. Consequently, as the first bent portion 330 is deflected, the optical axis 26 changes in a range between an optical axis 26a′ and an optical axis 26b′. The angular adjustment of the optical axis 26 is carried out in this range. An angle α′ formed by the optical axis 26a′ and the optical axis 26b′ is approximately 5° to approximately 20° in the direction of the arrows A′. Similarly, as the second bent portion 340 is deflected in the direction of the arrows B′, as shown in FIG. 7, the angle of the optical axis 26 of the light source 210 mounted on the heat input portion 310 changes, as shown by the dotted line and the thick line in FIG. 7. The optical axis 26 changes in a range between an optical axis 26c′ and an optical axis 26d′, and the angular adjustment of the optical axis 26 is carried out in this range. An angle β′ formed by the optical axis 26c′ and the optical axis 26d′ is approximately 5 to approximately 20′ in the direction of the arrows B′. Thus, since the angular adjustment of the optical axis 26 can be made in the range between approximately 5° and approximately 20° in the directions of the arrows A′ and B′, respectively, angular adjustment can be made in the range between approximately 5° and approximately 20′ in all directions by combining them. Namely, in the downlight 50, the angular adjustment of the optical axis 26 can be made by bending the respective bent portions 330 and 340 without changing the installation angle of the entire device, so that the operation does not become complicated. Furthermore, the angular adjustment of the optical axis 26 can be easily performed once the device has been assembled. Meanwhile, the heat of the light source 210 is released from the heat sink 400 by means of the heat pipe 300. As a result, the radiation of the light source 210 is effected efficiently.

As described above, despite its simple configuration the downlight 50 has combined an excellent heat dissipation characteristic based on the heat pipe 300 and the ease of angular adjustment of the optical axis 26.

### Third Embodiment

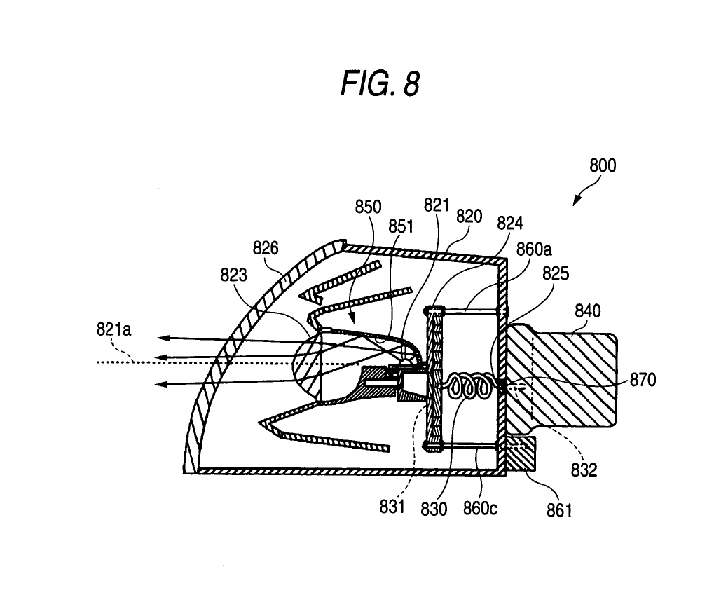

FIG. 8 shows a vertical cross-sectional view of a headlight 800 for a vehicle according to a third embodiment of the invention. The headlight 800 is comprised of a housing 820, an outer lens 826, a heat pipe 830, a heat sink 840, and a light source unit 850. The light source unit 850 has a base 824 of a flat plate shape, and a light source 821 is provided on a seat portion in its center. The light source 821 is a white LED lamp. The light source unit 850 has a lens 823 provided on the front side (in a direction facing the outer lens 826). A reflector 851 is provided on the light emitting side of the light source 821. The reflector 851 has a semi-dome shape in which the front side is open, and reflects the light of the light source 821 in the direction toward the lens 823.

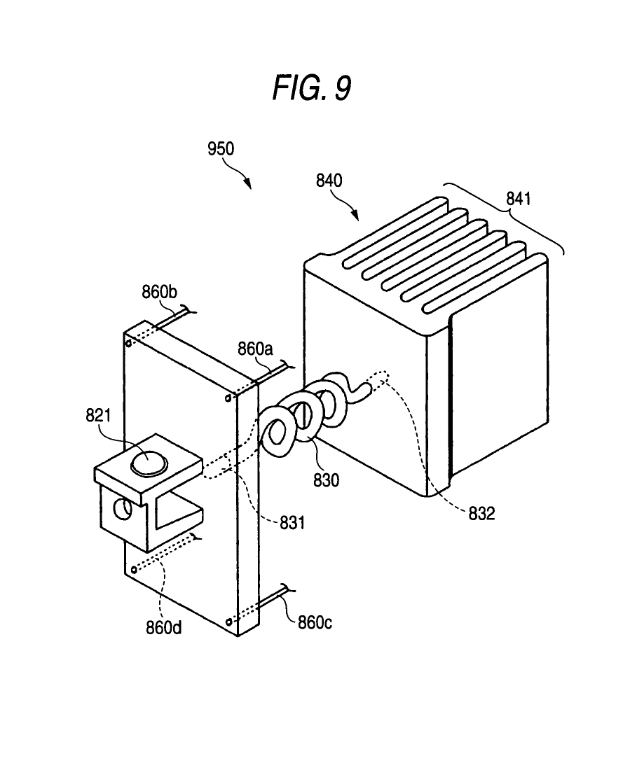

A part of the light source unit 850, the heat pipe 830, and the heat sink 840 are extracted, and a perspective view thereof is shown in FIG. 9. As shown in FIGS. 8 and 9, the base 824 is fixed to the housing 820 by means of four shafts 860a to 860d fixed to four corners of the base 824. An optical axis adjuster 861 is mounted on an end portion on the housing 820 side of the shaft 860c. The optical axis adjuster 861 pushes out or pulls in the shaft 860c in correspondence with the laden weight of the vehicle.

The heat pipe 830 has a spiral shape, and is passed through the housing 820 through a through hole 825 formed in the housing 820. An end portion on the light source 821 side of the heat pipe 830 serves as a heat input portion 831, while an end portion on the heart sink 840 side serves as a heat discharging portion 832. The heat input portion 831 is embedded in the center of the reverse surface of the base 824. Meanwhile, the heat discharging portion 832 is embedded in the heat sink 840 provided on the reverse surface side of the housing 820. The heat sink 480 is formed of aluminum and has a multiplicity of plate-like radiation fins 841. The radiation fins 841 are provided uprightly in a direction perpendicular to a horizontal plane and are parallel to each other. It should be noted that a gap between the housing 820 and the heat pipe 830 is sealed by a waterproof seal 870.

Next, a description will be given of the angular adjustment of the optical axis of the headlight 800. If the laden weight of the vehicle having the headlight 800 increases, the optical axis adjuster 860 correspondingly pulls in the shaft 860c. As a result, the installation angle of the entire light source unit 850 changes, so that an optical axis 821a of the emitted light changes so as to be oriented downward. In conjunction with this, the heat pipe 830, which is spiral in shape, is deflected (deformed). On the other hand, if the laden weight of the vehicle having the headlight 800 decreases, the optical axis adjuster 860 correspondingly pushes out the shaft 860c. As a result, the installation angle of the entire light source unit 850 changes, so that an optical axis 821a of the emitted light changes so as to be oriented upward. In conjunction with this, the spiral heat pipe 830 is deflected (deformed). As the heat pipe 830 is thus deflected, the angular adjustment of the optical axis 821a is easily made without changing the installation angle of the entire headlight 800. Meanwhile, since the through hole 825 is sealed by the waterproof seal 870, the interior of the housing 820 is made waterproof. In addition, with the headlight 800 as well, the heat of the light source 821 is efficiently released to the outside through the heat pipe 830 and the heat sink 830 in the same way as the headlight 1, and a high dissipation effect is exhibited.

It should be noted that although, in this embodiment, the arrangement provided is such that the angular adjustment of the optical axis 821a is automatically made by the optical axis adjuster 861 in correspondence with a change of the laden weight of the vehicle, the invention is not limited to the same. For example, a the shaft 860c may be provided with a screw mechanism, and the angle of the base 824 may be changed by manually rotating the shaft 860c so as to perform the angular adjustment of the optical axis 821a.

### Fourth Embodiment

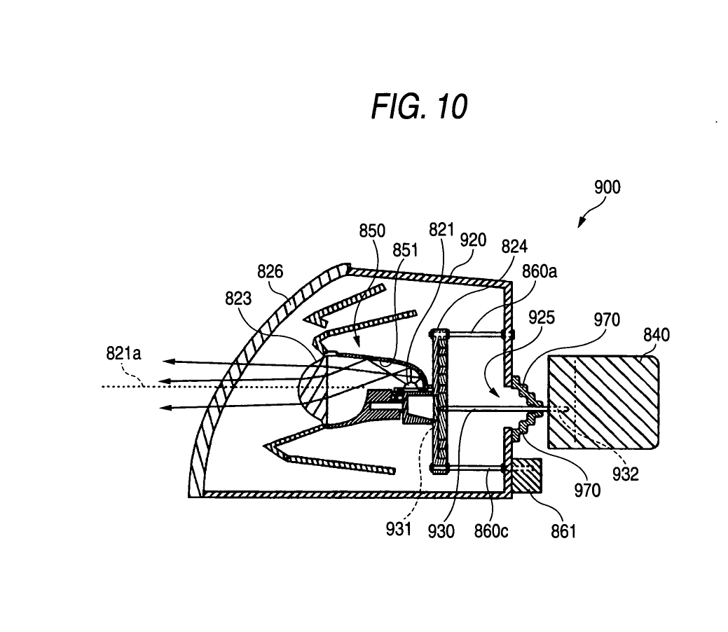

FIG. 10 shows a vertical cross-sectional view of a headlight 900 for a vehicle according to a fourth embodiment of the invention. It should be noted that those members that are substantially identical to those of the headlight 800 will be denoted by the same reference numerals, and a description thereof will be omitted. The headlight 900 has a heat pipe 930. The heat pipe 930 is rectilinear, and one end serves as a heat input portion 931, while the other end serves as a heat discharging portion 932. The heat pipe 930 is passed through the housing 920 through a through hole 925 formed in a housing 920. The heat input portion 931 is embedded in the center of the reverse surface of the base 824. Meanwhile, the heat discharging portion 932 is embedded in the heat sink 840 provided in the rear of the housing 920. A boot 970 seals the gap between the housing 920 and the heat pipe 930. The boot 970, which is formed of chloroprene rubber, has a bellows shape and is flexible.

With the headlight 900, in the same way as the headlight 800, the angle of the light source unit 850 is automatically adjusted by the optical axis adjuster 860 in correspondence with a change of the laden weight of the vehicle. The flexible boot 970 is deformed so as to follow the angular adjustment. Namely, the angles of the heat pipe 930 and the heat sink 840 also change so as to follow the angular change of the light source unit 850. As the boot 970 is thus deformed, the angular adjustment of the optical axis 821a is easily made without changing the installation angle of the headlight 900 per se. Furthermore, since the boot 970 seals the gap between the housing 920 and the heat pipe 930, the housing 920 is made waterproof. In addition, with the headlight 900 as well, the heat of the light source 821 is efficiently released to the outside through the heat pipe 930 and the heat sink 840 in the same way as the headlight 800, and a high dissipation effect is exhibited.

### Fifth Embodiment

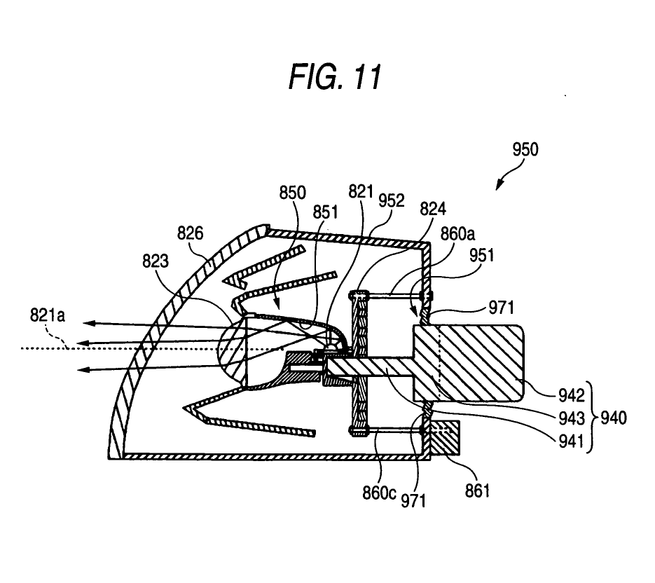

FIG. 11 shows a vertical cross-sectional view of a headlight 950 for a vehicle according to a fifth embodiment of the invention. It should be noted that those members that are substantially identical to those of the headlights 800 and 900 will be denoted by the same reference numerals, and a description thereof will be omitted. The headlight 950 has a heat sink 940. The heat sink 940 has a rod-shaped portion 941, a plate-shaped fin portion 942, and a flat plate portion 943. The rod-shaped portion 941 projects from the center of one surface (front surface) of the flat plate portion 943, while the plate-shaped fin portion 942, which is constituted by a plurality of plate-shaped fins oriented in a perpendicular direction, projects from the other surface (rear surface) of the flat plate portion 943. The heats ink 940 is passed through a housing 952 through a through hole 951. A boot 971 is bonded to the housing 952 and lateral peripheral surfaces of the flat plate portion 943 of the heat sink 940 so as to seal the gap between the housing 952 and the heat sink 940. The boot 970 formed of chloroprene rubber has a bellows shape and is flexible. The light source 821 is disposed on the upper surface of the rod-shaped portion 941.

With the headlight 950, in the same way as the headlight 900, the angle of the heat sink 940 also changes by following the angular change of the light source unit 850. As the boot 970 is thus deformed, the angular adjustment of the optical axis 821a is easily made without changing the installation angle of the headlight 950 per se. Furthermore, the heat of the light source 821 is propagated to the rod-shaped portion 941 of the heat sink 940, and after moving from the rod-shaped portion 941 to the plate-shaped fin portion 942 through the flat-plate portion 943, the heat is released from the plate-shaped fin portion 942 to the outside. In the same way as the headlights 1, 800, and 900, the heat of the light source 821 is efficiently released to the outside by the heat sink 940, and a high dissipation effect is exhibited. Thus, the rod-shaped portion 941 functions as the heat transfer portion for propagating the heat of the light source 821 to the plate-shaped fin portion 942. Namely, the heat sink 940 has combined the heat transfer portion and the heat dissipation portion. Hence, as the number of parts is decreased, the manufacturing cost is reduced, and the assembling process is simplified. In addition, in the same way as the headlight 900, since the gap between the housing 952 and the heat sink 940 is sealed by the boot 970, the interior of the housing 952 is made waterproof.

### Sixth Embodiment

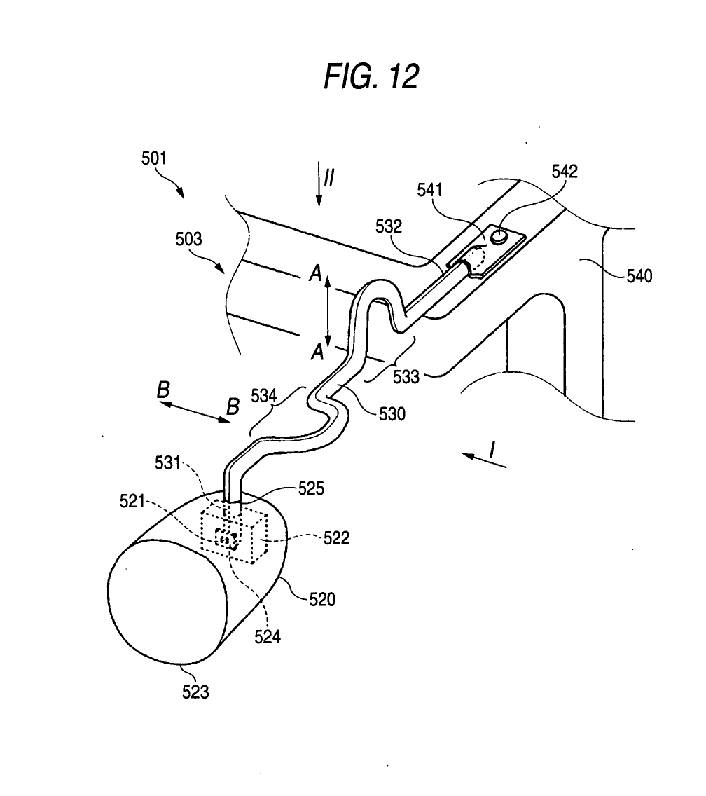

FIG. 12 shows a perspective view of a light source unit 503 of a headlight 501 according to the sixth embodiment. As shown in FIG. 12, the light source unit 503 is comprised of a housing 520 and a heat pipe 530. The housing 520 has a light source 521 accommodated therein. The light source 521 is a white light emitting LED lamp of a surface mounted type, and its LED chip is mounted on a mounting substrate 524. By taking the heat dissipation characteristic into consideration, a ceramic-made substrate is adopted as the mounting substrate 524. The light source 521 is mounted on one end portion (heat input portion 531) of the heat pipe 530 through a thermally conductive member 522. The thermally conductive member 522 is formed of aluminum, and is provided so as to be brought into contact with the entire reverse surface of the mounting substrate 524. In the housing 520, a lens 523 is provided on the light emitting side of the light source 521. The heat pipe 530 has the heat input portion 531 disposed on one end side for mounting the light source 521 thereon, a heat dissipation portion 532 disposed on the other end side, and a first bent portion 533 and a second bent portion 534 both disposed in the vicinities of a central portion. The heat dissipation portion 532 is clamped by a mounting stay 541 and an upper surface of a vehicle frame 540. Consequently, the heat dissipation portion is connected to the vehicle frame 540. It should be noted that the mounting stay 541 is fixed to the vehicle frame 540 by means of screws 542. The vehicle frame 540 and the mounting stay 541 are formed of metal.

The first bent portion 533 is bent in a substantially semicircular shape in the first direction (indicated by the arrows A in FIG. 12) which is a direction perpendicular to the traveling direction of the vehicle and the ground surface. Meanwhile, the second bent portion 534 is bent in a substantially semicircular shape in the second direction (indicated by arrows B in FIG. 12) which is perpendicular to the first direction and the longitudinal direction of the vehicle. Both of the first bent portion 533 and the second bent portion 534 are formed outside the housing 520. The heat pipe 530 has a diameter of approximately 6 mm and a length of approximately 300 mm. The housing 520 has a through hole 525 through which the heat pipe 530 is passed. A waterproof packing (not shown) is fitted to the through hole 525 to thereby prevent the invasion of water and the like into the housing 520 through the through hole 525. Additionally, the whole edge portion of the lens 523 is welded to the housing 520. As a result, the interior of the housing 520 is kept in a waterproof state.

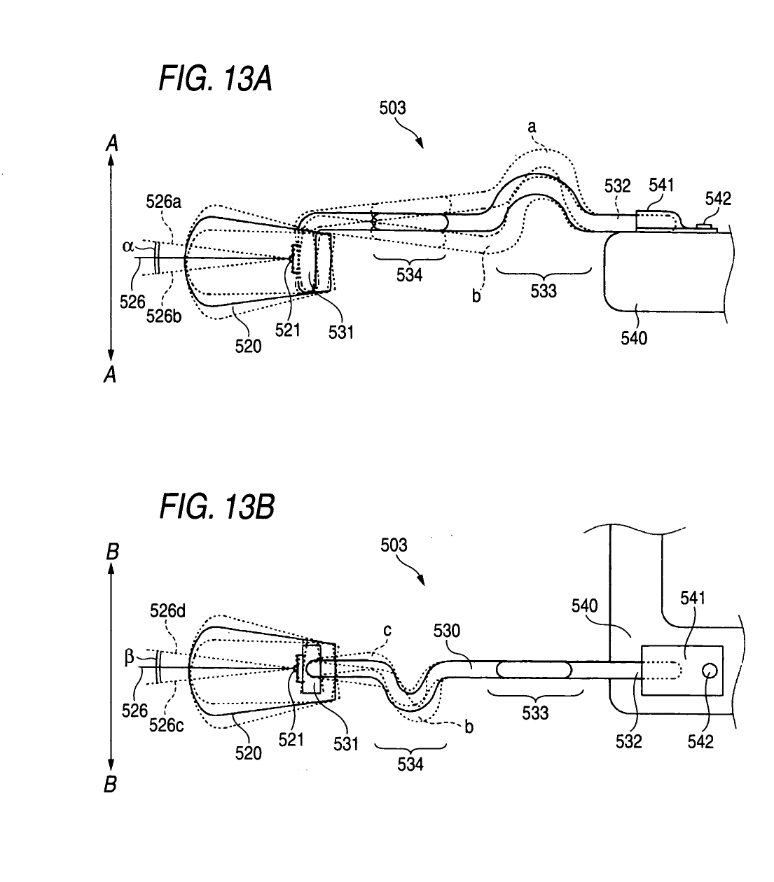

Next, a description will be given of the angular adjustment of the optical axis of the headlight 501. FIG. 13A shows a schematic view, taken from the angle shown at I in FIG. 12, of the light source unit 503. FIG. 13B shows a schematic view, taken from the angle shown at II in FIG. 12, of the light source unit 503. In FIGS. 13A and 13B, the state in which the first bent portion or the second bent portion is deflected is shown by the dotted line. As shown in FIG. 13A, the first bent portion 533 is deflected in the direction of the arrows A. The heat dissipation portion 532 side is fixed to the vehicle body, and the heat input portion 531 side moves as shown at a and b in FIG. 13A. In conjunction with this, an optical axis 526 of the light source 521 changes in a range between an optical axis 526a and an optical axis 526b. The angular adjustment of the optical axis 526 is carried out in this range. An angle α formed by the optical axis 526a and the optical axis 526b is approximately 5° to approximately 20° in the direction of the arrows A.

On the other hand, the second bent portion 534 is deflected in the direction of the arrows B, as shown in FIG. 13B. Since the heat dissipation portion 532 is fixed to the vehicle body, the heat input portion 531 side moves as shown at c and d in FIG. 13B. In conjunction with this, the optical axis 526 of the light source 521 changes in a range between an optical axis 526c and an optical axis 526d. The angular adjustment of the optical axis 526 is carried out in this range. An angle β formed by the optical axis 526c and the optical axis 526d is approximately 5° to approximately 20° in the direction of the arrows B.

Since, as described above, the angular adjustment of the optical axis 526 can be made in the range between approximately 5° and approximately 20° in the directions of the arrows A and B, respectively, angular adjustment can be made in the range between approximately 5° and approximately 20° in all directions by combining them. Namely, in the headlight 501, the angular adjustment of the optical axis 526 can be made by bending the respective bent portions 533 and 534 without changing the installation angle of the entire device, so that the operation does not become complicated. Furthermore, the angular adjustment of the optical axis 526 can be easily performed once the device has been assembled.

Incidentally, the heat generated from the light source 521 propagates to the heat input portion 531 of the heat pipe 530 through the thermally conductive member 522. The heat which reached the heat input portion 531 moves efficiently to the heat dissipation portion 532 by virtue of the radiating action of the heat pipe 530. The heat which moved to the heat dissipation portion 532 is propagated to the vehicle frame 540. The vehicle frame 540 is formed of metal, and has a sufficient heat capacity. Therefore, the vehicle frame 540 is capable of receiving a sufficient amount of heat from the heat dissipation portion 532. Part of the received heat is released to the outside while moving through the interior of the vehicle frame 540. As a result, the light source 521 is prevented from heating excessively.

As described above, despite its simple configuration the headlight 501 has combined an excellent heat dissipation characteristic based on the heat pipe 530 and the ease of angular adjustment of the optical axis 526. Furthermore, since it is unnecessary to provide a heat dissipating member separately, the headlight is made compact and lightweight as compared with the case where the heat dissipating member is installed in the housing. Additionally, the compact size contributes to the improvement of the degree of freedom in designing the vehicle.

### Seventh Embodiment

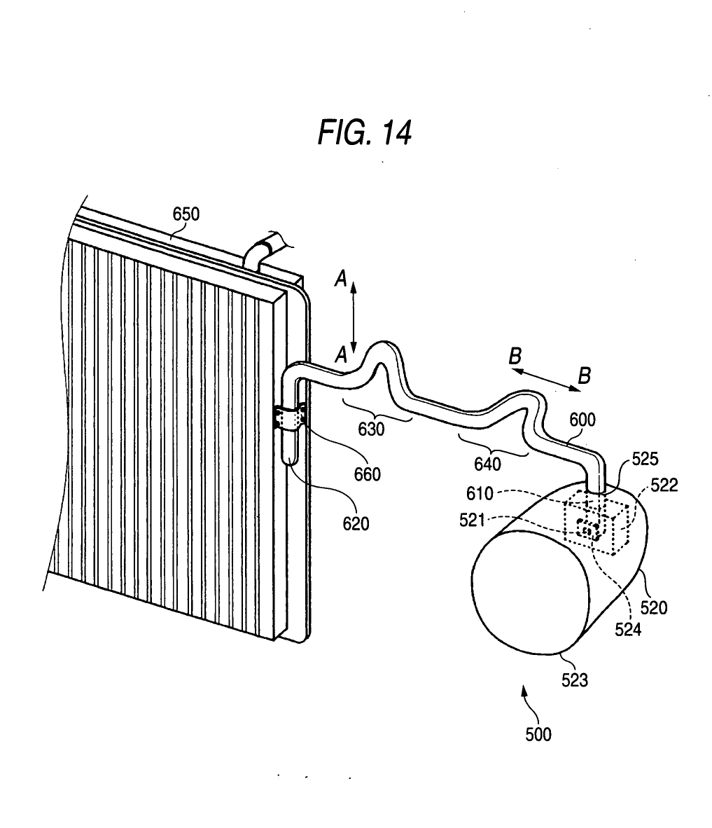

FIG. 14 shows a perspective view of a headlight 500 according to the seventh embodiment of the invention. Those members that are identical to those of the headlight 500 will be denoted by the same reference numerals, and a description thereof will be omitted. As shown in FIG. 14, the headlight 500 is comprised of the housing 520 and a heat pipe 600. The heat pipe 600 has a heat input portion 610, a heat dissipation portion 620, a first bent portion 630, and a second bent portion 640. The heat dissipation portion 620 is connected by means of a mounting stay 660 to a radiator 650 for cooling the vehicle engine. In the headlight 500, the heat of the light source 521 is propagated to the heat pipe 600 and moves to the heat dissipation portion 620. The heat which reached the heat dissipation portion 620 is released to the outside by the radiator 650. As a result, the light source 521 is effectively prevented from heating excessively. With the headlight 500, as the first bent portion 630 and the second bent portion 640 are respectively bent in the direction of arrow A and in the direction of arrow B, the angular adjustment of the optical axis after assembly is facilitated. Thus, the headlight 500 exhibits advantages similar to those of the headlight 500.

### Eighth Embodiment

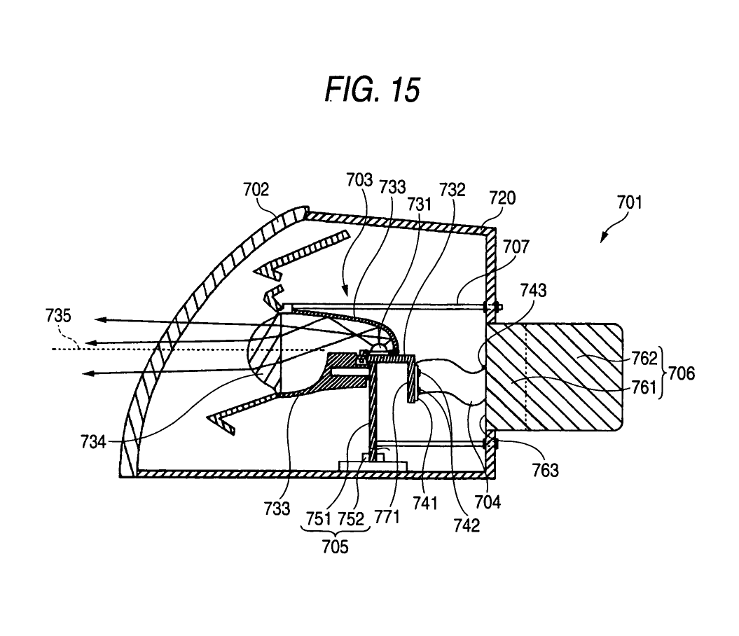

In the eighth embodiment, as shown in FIG. 15, the light source unit 703, a graphite sheet 704, and an optical axis adjusting mechanism 705 are accommodated in a housing 720. Meanwhile, a heat sink 706 is provided on the reverse surface side of the housing 720. The light source unit 703 has an LED lamp 731, a seat 732, a reflector 733, and a lens 734. The light source 731 is a white light emitting LED lamp of a surface mounted type. The seat 732 is formed of a metal having high thermal conductivity, such as aluminum or copper, by taking the heat dissipation characteristic into consideration, and the LED lamp 731 is disposed on the upper surface of the seat 732. The reflector 733 is provided on the light emitting side of the LED lamp 731, its shape is that of a dome, and it is enlarged in diameter on the outer lens 702 side and is open. The inner surface of the reflector 733 is formed as a reflecting surface. The lens 731 is provided on the outer lens 702 side of the reflector 733. The light of the LED lamp 731 is reflected by the reflector 733, is transmitted through the lens 734, and travels toward the outer lens 702 side.

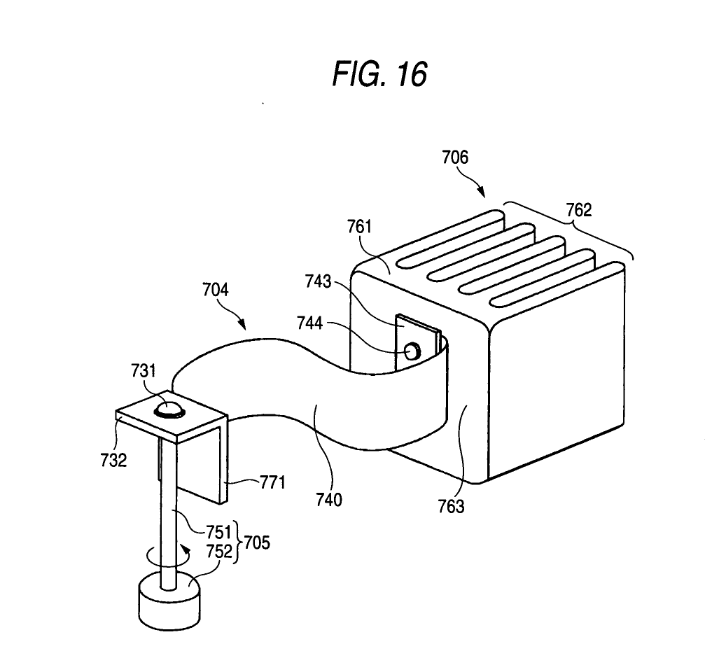

The LED lamp 731, the seat 732, the graphite sheet 704, the optical axis adjusting mechanism 705, and the heat sink 706 are extracted, and a perspective view thereof is shown in FIG. 16. The heat sink 706 is made of aluminum, and has a cubic base portion 761 and a plurality of fins 762 provided vertically uprightly on the base portion 761, as shown in FIG. 16. The heat sink 706 is provided so as to be passed through an opening in the rear surface of the housing 720 such that a bottom surface 763 of the base portion 761 is exposed on the inner side of the housing 720, while the fins 762 are exposed in the rear of the housing 720 (see FIG. 15). It should be noted that a waterproof packing (not shown) is fitted between the opening in the rear surface of the housing 720 and the heat sink 706 to thereby prevent the invasion of water and the like into the housing 720. Additionally, the whole edge portion of the outer lens 702 is welded to the housing 720. As a result, the interior of the housing 720 is kept in a waterproof state.

In this embodiment, the heat discharging member of the invention includes the seat 732 having an extending portion 771 and the graphite sheet 4. The graphite sheet 704 has a sheet shape with a length of approx. 50 mm and a width of approx. 50 mm. One end of the graphite sheet 704 is fixed by bolts 712 to the extended portion 771 extending downward from the seat 732, so as to be clamped by an aluminum plate 741 and the seat 732 (see FIG. 15). It should be noted that the graphite sheet 704 is fixed to the extended portion 771 of the seat 732 such that a flat surface portion 740 of the graphite sheet 704 becomes in parallel to the axial direction of a rotating shaft 751 of the optical axis adjusting mechanism 705 which will be described later (see FIG. 16). Meanwhile, the other end of the graphite sheet 704 is fixed to the bottom surface 763 of the heat sink 706 by bolts 744 so as to be clamped by an aluminum plate 743 and the bottom surface 763, as shown in FIG. 16. It should be noted that the graphite sheet 704 is fixed to the extended portion 771 of the seat 732 and to the bottom surface 763 of the heat sink 706 in a sufficiently slackened state. In addition, the surface of the graphite sheet 704 is provided with a coating for preventing scarring (e.g., a coating with a polyimide resin). It should be noted that the seat 732 may be made thick, and the graphite sheet 704 may be fixed to its side surface. Further, a plurality of the graphite sheets 704 maybe used. In this case, the dissipation effect improves if one ends on the heat sink 706 side of the graphite sheet 704 are fixed at horizontally and vertically different positions on the bottom surface 763 of the heat sink 706.

The optical axis adjusting mechanism 705 has the rotating shaft 751 and a motor drive unit 752. An upper end of the rotating shaft 751 is connected to the seat 732, while a lower end of the rotating shaft 751 is connected to the motor drive unit 752. The motor drive unit 752 is connected to a control circuit (not shown), and is controlled so as to be driven in correspondence with the steering angle of the steering wheel of the vehicle. It should be noted that the headlight 701 for a vehicle is provided with an aiming screw 707, which also enables the angular adjustment of the optical axis 731 of the light source unit 703 from outside the housing 720.

Next, a description will be given of the form of heat dissipation of the headlight 701 for a vehicle. The LED lamp 731 is mounted on the metallic seat 732 having high thermal conductivity, so that the heat of the LED lamp 731 is propagated to the seat 732. The heat propagated to the seat 732 is propagated to one end of the graphite sheet 704 fixed to the extended portion 771 of the seat 732, and is further propagated to from the other end of the graphite sheet 704 to the heat sink 706. The heat propagated to the heat sink 706 is released from the fins 762 exposed on the outer side of the housing 720 to outside the housing 720. Since the graphite sheet 704 has high thermal conductivity, the heat of the LED lamp 731 is efficiently propagated to the heat sink 706, thereby exhibiting a high dissipation effect. Since the graphite sheet 704 has a thin sheet shape and is lightweight, the entire device is constructed to be compact and lightweight. Further, since the graphite sheet 704 has its strength enhanced by a coating (e.g., a coating with a polyimide resin), handling is facilitated, and the operating efficiency in installation is high.

Next, a description will be given of the angular adjustment of an optical axis 735 of the headlight 701 for a vehicle. First, at the time of installation of the headlight 701 for a vehicle, the aiming screw 707 is rotated to cause the light source unit 703 to be pushed toward the outer lens 702 side or to be pulled in toward the rear surface side of the housing 720, thereby effecting the angular adjustment of the optical axis 735 by changing the installation angle of the light source unit 703. Meanwhile, after the installation, the motor drive unit 752 rotates the rotating shaft 751 in the axial direction by the optical axis adjusting mechanism 705 in correspondence with the steering angle of the steering wheel of the vehicle. The upper end of the rotating shaft 751 is connected to the seat 732, and as the rotating shaft 751 rotates, the installation angle of the entire light source unit 703 is changed. As a result, the angular adjustment of the optical axis 735 is carried out. In the above-described angular adjustment of the optical axis 735, as the installation angle of the light source unit 703 is changed, the graphite sheet 704 is deformed. The graphite sheet 704 is flexible and is installed in a sufficiently slackened state, so that when the installation angle of the light source unit 703 is changed, the graphite sheet 704 is correspondingly deformed. Hence, the angular adjustment of the optical axis 735 can be easily carried out without applying an excessive tension to the graphite sheet 704 itself and other members and without changing the installation position of the entire headlight 701 for a vehicle. Thus, with the headlight 701 for a vehicle, as the angular adjustment of the optical axis 735 is effected in correspondence with the steering angle of the steering wheel of the vehicle, the traveling direction of the vehicle can be actively illuminated, thereby making it possible to improve the visibility of the driver.

The luminescent device according to the invention can be utilized in various illumination applications such as the headlights for vehicles.

What is claimed is:

1. A luminescent device comprising:
a light source;
a housing for accommodating the light source,
a heat discharging member passed through the housing;
a seal portion for sealing a gap between the heat discharging member and the housing; and
an optical axis adjusting device for adjusting an optical axis of the light source,
wherein the heat discharging member or the seal portion is deformed so as to follow an angular change of the optical axis of the light source by the optical axis adjusting device.

2. The luminescent device according to claim 1, wherein the heat discharging member includes a heat transfer portion and a heat dissipation portion, and
the heat transfer portion is mounted on the light source and the heat dissipation portion is located outside the housing.

3. The luminescent device according to claim 2, wherein the heat transfer portion is constituted by a heat pipe, a heat input portion of the heat pipe is mounted on the light source, and a heat discharging portion of the heat pipe is mounted on the heat dissipation portion.

4. The luminescent device according to claim 3, wherein the heat pipe has outside the housing a first bent portion which is deflected in a first direction.

5. The luminescent device according to claim 4, wherein the heat pipe has outside the housing a second bent portion which is deflected in a second direction.

6. The luminescent device according to claim 5, wherein the second direction is perpendicular to the first direction.

7. The luminescent device according to claim 3, wherein the heat pipe has a spiral shape.

8. The luminescent device according to claim 4, further comprising: a heat sink provided outside the housing and the heat dissipation portion has a radiation fin.

9. The luminescent device according to claim 2, wherein the seal portion seals a gap between the heat transfer portion and the housing.

10. The luminescent device according to claim 2, wherein the seal portion seals a gap between the heat dissipation portion and the housing.

11. The luminescent device according to claim 2, wherein the seal portion is formed by a flexible boot member.

12. The luminescent device according to claim 2, wherein a heat conducting member is interposed between the light source and the heat transfer portion.

13. The luminescent device according to claim 1, wherein the heat discharging member includes a flexible heat conducting member for conducting the heat of the light source to a heat dissipating member.

14. The luminescent device according to claim 13, wherein the heat conducting member is a graphite sheet.

15. The luminescent device according to claim 13, wherein the heat discharging member further comprising:
a thermally conductive seat for mounting the light source thereon,
wherein an end of the heat conducting member is connected to the seat, and another end of the heat conducting member is connected to the heat dissipating member.

16. The luminescent device according to claim 15, wherein the optical axis adjusting device includes a mechanism for changing an installation angle of the light source in correspondence with a steering angle of a steering wheel of the vehicle.

17. The luminescent device according to claim 1, wherein the light source is an LED lamp.
